(19) United States
(12) Patent Application Publication
(10) Pub. No.: US 2025/0382992 A1
(43) Pub. Date: Dec. 18, 2025

(54) BEARING WITH RETAINER

(71) Applicant: NACHI-FUJIKOSHI CORP., Tokyo (JP)

(72) Inventor: Takao TERADA, Toyama (JP)

(73) Assignee: NACHI-FUJIKOSHI CORP., Tokyo (JP)

(21) Appl. No.: 19/230,088

(22) Filed: Jun. 6, 2025

(30) Foreign Application Priority Data
Jun. 13, 2024 (JP) 2024-095639

(51) Int. Cl. F16C 33/44; F16C 19/06

(52) U.S. Cl. CPC F16C 33/44; F16C 19/06

(57) ABSTRACT

An object is to provide a bearing with a retainer that enables size reduction of the bearing while minimizing changes to the layout of components surrounding the bearing. A configuration of the bearing with the retainer according to the present invention includes the outer ring; the inner ring; the ball that is rollable between the outer ring and inner rings; and the resin crown-type retainer, with which the ball is retained, wherein, on the side where the back surface of the retainer is positioned, one end surface position of the outer ring or the inner ring is positioned outward of the back surface of the retainer, while the other end surface position of the outer ring or the inner ring is positioned inward of the back surface of the retainer.

### CROSS-REFERENCE TO RELATED APPLICATIONS

This application is based upon and claims the benefit of priority from the prior Japanese Patent Application No. 2024-095639, filed on Jun. 13, 2024, the entire contents of which are incorporated herein by reference.

### BACKGROUND OF THE INVENTION

### Field of the Invention

The present invention relates to a bearing with a retainer that is equipped with a resin crown-type retainer.

### Description of the Related Art

It is common for bearings to use a retainer. The retainer is designed to maintain appropriate spacing between rolling elements (such as balls or rollers) by retaining each rolling element in a respective one of a plurality of pockets, thereby preventing friction between the rolling elements. Retainers to be used come in various shapes, one of which is a crown-type retainer.

For example, Patent Document 1 (Japanese Patent Application Laid-Open No. 2020-122556) discloses “a multi-point contact ball bearing that has an inner ring having an inner raceway groove on its outer peripheral surface, an outer ring having an outer raceway groove on its inner peripheral surface, a plurality of balls arranged to roll freely between the inner raceway groove and the outer raceway groove, and a resin crown-type retainer having a plurality of pockets for rotatably holding the balls”.

### SUMMARY OF THE INVENTION

In order to solve the above problems, a representative configuration of a bearing with a retainer according to the present invention includes: an outer ring; an inner ring; a ball that is rollable between the outer ring and inner ring; and a resin crown-type retainer, with which the ball is retained, wherein, on a side where a back surface of the retainer is positioned, one end surface position of the outer ring or the inner ring is positioned outward of the back surface of the retainer, while the other end surface position of the outer ring or the inner ring is positioned inward of the back surface of the retainer.

### BRIEF DESCRIPTION OF THE DRAWINGS

FIG. 1 is a schematic diagram illustrating the first embodiment of the bearing with the retainer according to the present invention.

FIG. 2 is a schematic diagram illustrating the second embodiment of the bearing with the retainer according to the present invention.

FIG. 3A is a diagram illustrating a configuration in which the bearing of the first embodiment is assembled to a housing and a shaft.

FIG. 3B is a diagram illustrating a configuration in which the bearing of the second embodiment is assembled to the housing and the shaft.

FIG. 3C is a diagram illustrating a configuration in which the bearing of the comparative example is assembled to the housing and shaft.

FIG. 3D is a diagram illustrating the bearing assembled in a reverse orientation.

FIG. 4A is a diagram explaining the mounting of the bearing in the housing according to the embodiments.

FIG. 4B is a diagram explaining the mounting of the bearing in the housing according to the embodiments in a reverse orientation.

FIG. 5A is a diagram illustrating a stacked state of the bearings in the first embodiment.

FIG. 5B is a diagram illustrating a stacked state of the bearings in the comparative example.

### EMBODIMENTS FOR CARRYING OUT THE INVENTION

The following describes preferred embodiments of the present invention in detail with reference to the attached drawings. The dimensions, materials, and other specific values shown in these embodiments are merely examples provided to facilitate the understanding of the invention and do not limit the invention, unless otherwise specified. In the present specification and drawings, elements with essentially the same functions and configurations are assigned the same reference numerals to avoid redundant explanations, and elements unrelated to the present invention are omitted from the drawings.

### <First Embodiment of the Bearing 100>

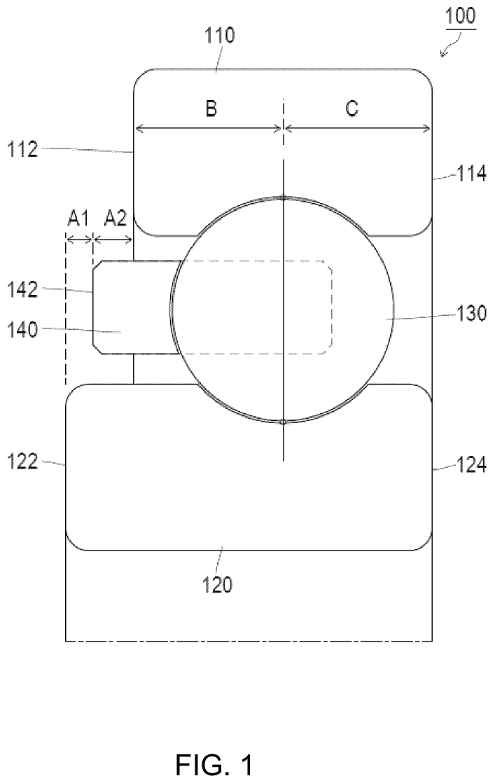

FIG. 1 is a schematic diagram illustrating a bearing with a retainer according to a first embodiment of the present invention. The bearing 100 of the first embodiment may be exemplified by a deep groove ball bearing or a multi-point contact ball bearing. FIG. 1 shows an example of the deep groove ball bearing, which has two points of contact and a contact angle of 0 degrees.

As shown in FIG. 1, the bearing 100 of the first embodiment is equipped with an outer ring 110, an inner ring 120, a ball 130 as a rolling element that rolls between the outer ring 110 and the inner ring 120, and a resin crown-type retainer 140 that retains the ball. Since FIG. 1 is a cross-sectional view of the annular bearing 100, only one rolling element (ball 130) is illustrated; however, in practice, the bearing 100 includes a plurality of rolling elements 130.

In the bearing 100 according to this embodiment, on the side where a back surface 142 of the retainer 140 is located, an end surface 122 of the inner ring 120 (end surface position) is positioned outward of the back surface 142 of the retainer 140 by a width A1. Also, an end surface 112 of the outer ring 110 (end surface position) is positioned inward of the back surface 142 of the retainer 140 by a width A2.

Further, in the bearing 100 according to this embodiment, the outer ring 110 is configured to have a narrow width, and a width B from the center of the ball 130 to the end surface 112 is set equal to a width C from the center of the ball 130 to an end surface 114. That is, the outer ring 110 has a symmetrical shape in the width direction with respect to the ball 130.

Viewed from a different perspective with respect to the above configuration, it can be said that the outer ring 110 has a minimal width sufficient to allow the ball 130 to roll, whereas the inner ring 120 has a greater width on the back surface side of the retainer 140 to protect the retainer 140.

According to the above configuration, the width of the outer ring 110 can be reduced, thereby enabling the overall size of the bearing 100 to be minimized. Additionally, as described later, protecting the retainer 140 with the inner ring 120 allows changes in the layout of the components surrounding the bearing 100 to be minimized, as compared to a configuration in which the widths of both the outer ring 110 and inner ring 120 are reduced.

Furthermore, in the bearing 100 according to this embodiment, on the side opposite the back surface 142 of the retainer 140, the end surface 114 of the outer ring 110 and the end surface 124 of the inner ring 120 are aligned. Specifically, the end surface positions of the outer ring 110 and inner ring 120 on the side opposite the back surface 142 of the retainer 140 are arranged near the ball 130, within a range in which the ball 130 can be held. This configuration allows for further miniaturization of the bearing 100.

### <Second Embodiment of the Bearing 200>

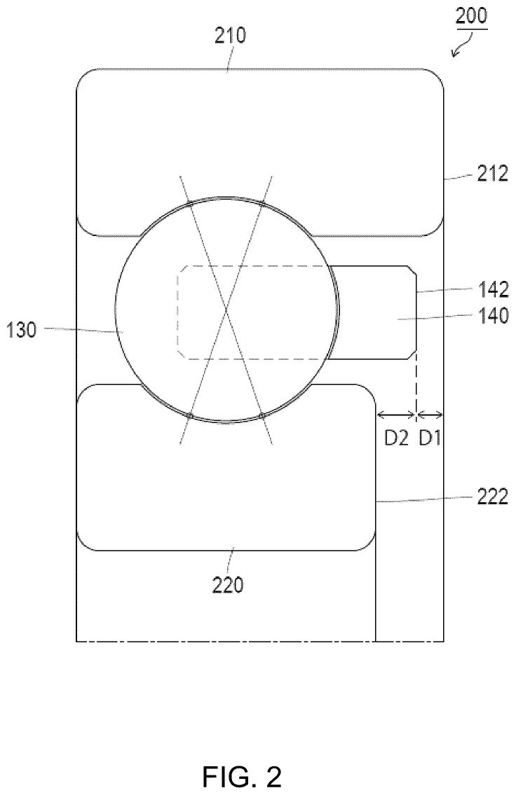

FIG. 2 is a schematic diagram illustrating a bearing with a retainer according to a second embodiment of this invention. Components common to the bearing 100 of the first embodiment are denoted by the same reference numerals, and thus, the detailed descriptions thereon are omitted. Also, configurations similar to those of the bearing 100 of the first embodiment are omitted. FIG. 2 illustrates an example of a four-point contact bearing as a multi-point contact example, in which four contact points are provided with a predetermined contact angle. As another example not shown in the figures, the present invention can also be applied to a three-point contact ball bearing.

In the bearing 200 of the second embodiment, on the side where the back surface 142 of the retainer 140 is located, an end surface 212 of the outer ring 210 (end surface position) is positioned outward of the back surface 142 of the retainer 140 by a width D1. Also, an end surface 222 of the inner ring 220 (end surface position) is positioned inward of the back surface 142 of the retainer 140 by a width D2. This configuration can also achieve similar effects to the bearing 100 of the first embodiment.

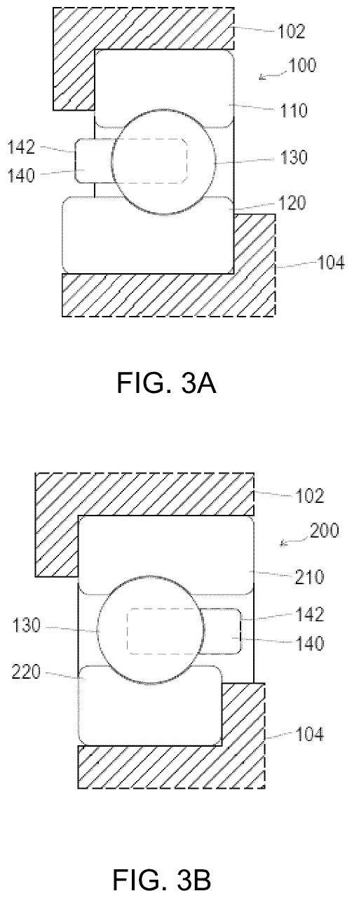

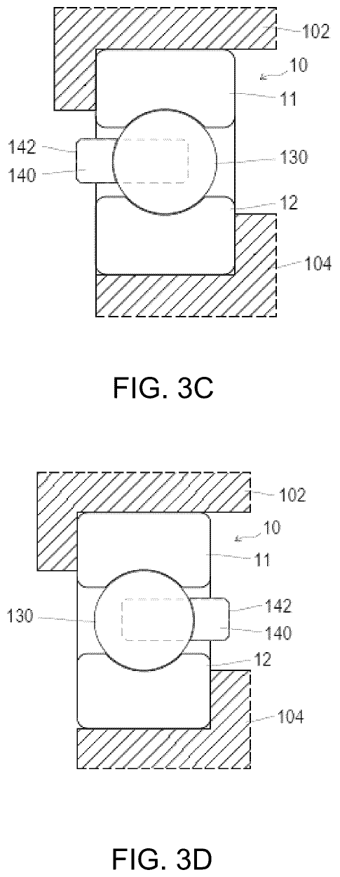

FIG. 3A is a diagram illustrating a configuration in which the bearing 100 of the first embodiment is assembled to a housing 102 and a shaft 104. FIG. 3B is a diagram illustrating a configuration in which the bearing 200 of the second embodiment is assembled to the housing 102 and the shaft 104. FIG. 3C is a diagram illustrating a configuration in which a bearing 10 of the comparative example is assembled to the housing 102 and the shaft 104, and FIG. 3D is a diagram illustrating the bearing 10 assembled in a reverse orientation.

In the bearing 10 of the comparative example shown in FIG. 3C and FIG. 3D, both the outer ring 11 and the inner ring 12 are configured to have minimal widths sufficient to allow the balls 130 to roll. Consequently, the retainer 140 is left in a protruding state. In addition, the bearing 10 has a symmetrical shape with respect to the center of the ball 130, which allows it to be assemble in reverse, potentially causing the retainer 140 to protrude on the opposite side.

In the configuration shown in FIG. 3C, the outer ring 11 side of the retainer 140 is protected by the housing 102; however, the inner ring 12 side is not protected. Further, in the configuration shown in FIG. 3D, the inner ring 12 side of the retainer 140 is protected by the shaft 104; however, the outer ring 11 side is not protected. Therefore, in the bearing 10 of the comparative example, other components must be positioned at greater distances on both the left side and the right side to avoid contact, leading to constraints on the layout of surrounding components on both the inner ring 12 side and the outer ring 11 side. Consequently, achieving space savings becomes difficult.

In contrast, in the bearing 100 of the first embodiment shown in FIG. 3A, when assembled to the housing 102 and shaft 104, the inner ring 120 is positioned on the lower side of the back surface 142 of the retainer 140 in FIG. 3A, while the housing 102 is positioned on the upper side of the back surface 142 of the retainer 140 in the same figure. Therefore, the retainer 140 is protected from contact with surrounding components, which eliminates the risk of interference with the retainer 140 by surrounding components, even without taking any special measures.

In the bearing 200 of the second embodiment shown in FIG. 3B, when assembled to the housing 102 and shaft 104, the outer ring 210 is positioned on the upper side of the back surface 142 of the retainer 140 in FIG. 3B, while the shaft 104 is positioned on the lower side of the back surface 142 of the retainer 140 in the same figure. Therefore, similar to the bearing 100, there is no risk of other components interfering with the retainer 140, even without taking any special measures.

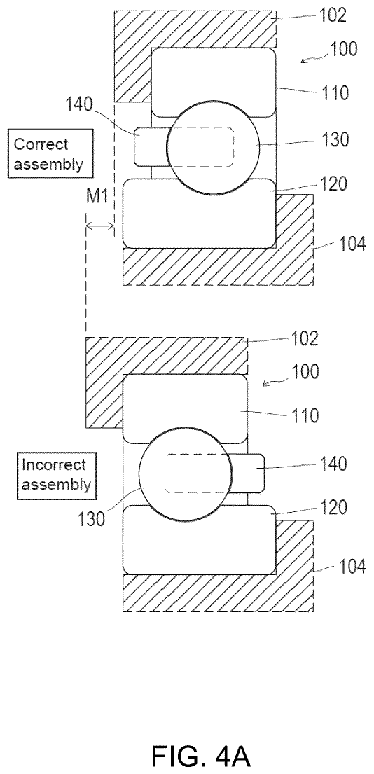

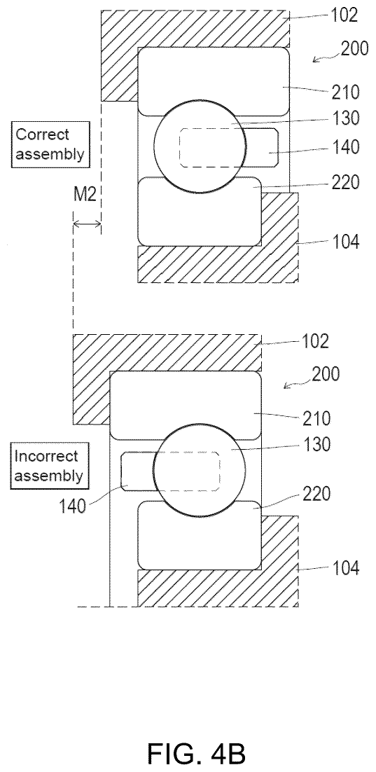

FIGS. 4A and 4B are diagrams explaining the mounting of the bearing of the embodiments to the housing 102.

Both the bearing 100 of the first embodiment and the bearing 200 of the second embodiment have an asymmetric shape relative to the center of the ball 130. Therefore, as shown in FIG. 4A and FIG. 4B, if the bearing 100 of the first embodiment or the bearing 200 of the second embodiment is mistakenly assembled, a misalignment M1 or M2 will occur between the housing 102 and the shaft 104. Thus, with the bearing 100 of the first embodiment and the bearing 200 of the second embodiment, incorrect assembly to the housing can be immediately detected.

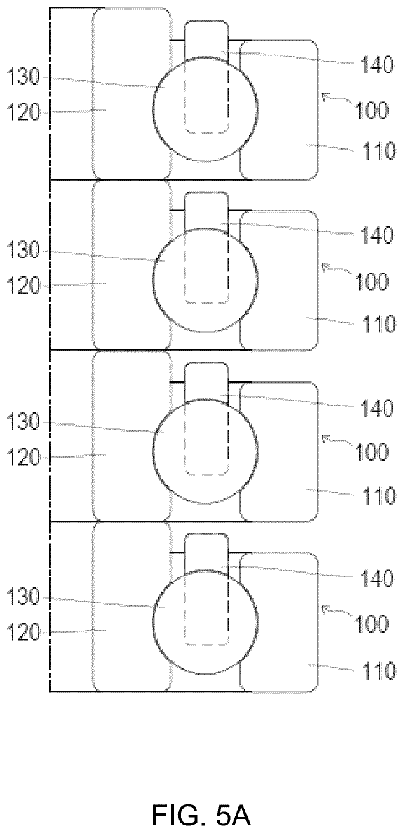

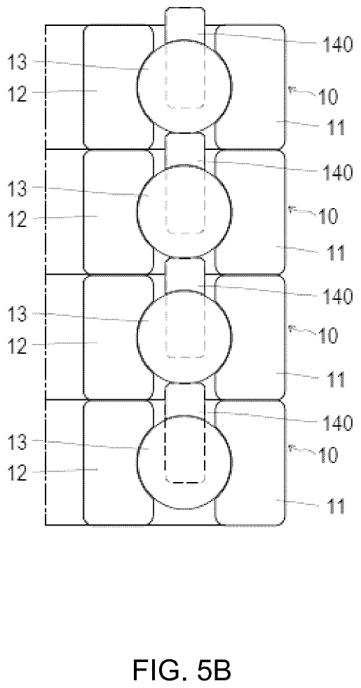

FIG. 5A and FIG. 5B illustrate a state in which the bearings are stacked. FIG. 5A shows the stacked state of the bearing 100 of the first embodiment. FIG. 5B shows the stacked state of the bearing 10 of the comparative example.

When multiple bearings 10 of the comparative example are stacked, as shown in FIG. 5B, the retainer 140 protrudes, potentially interfering with the ball 130 of the adjacent bearing 10. Therefore, careful handling, such as placing spacers between the bearings, is required.

In contrast, in the bearing 100 of the first embodiment, as shown in FIG. 5A, the outer ring 120, which has a greater width than the inner ring 110, come into contact with each other, thereby preventing interference between the retainer 140 and the ball 130 of the adjacent bearing 100. Accordingly, this configuration effectively prevents damage to the retainer 140 or the ball 130.

Although the preferred embodiments of the present invention have been described above with reference to the accompanying drawings, it is understood that the present invention is not limited to these examples. A person skilled in the art will readily recognize various modifications or changes that fall within the scope of the claims, and such modifications are understood to be included within the technical scope of the present invention.

### INDUSTRIAL APPLICABILITY

The present invention can be used as a bearing with a resin crown-type retainer.

What we claim is:

1. A bearing with a retainer, comprising:
an outer ring;
an inner ring;
a ball that is rollable between the outer ring and inner rings; and
a resin crown-type retainer, with which the ball is retained,
wherein, on a side where a back surface of the retainer is positioned, one end surface position of the outer ring or the inner ring is positioned outward of the back surface of the retainer, while the other end surface position of the outer ring or the inner ring is positioned inward of the back surface of the retainer.

2. The bearing with the retainer according to claim 1,
wherein, on a side opposite to the back surface of the retainer, end surface positions of the outer ring and the inner ring are aligned.
